(19) United States
(12) Patent Application Publication
(10) Pub. No.: US 2024/0151875 A1
(43) Pub. Date: May 9, 2024

(54) OPTICAL DEVICE

(71) Applicant: VisEra Technologies Company Limited, Hsin-Chu City (TW)

(72) Inventors: Wei-Hsun CHENG, Hsin-Chu City (TW); Chen-Yi YU, Hsin-Chu City (TW); Wei-Ko WANG, Hsin-Chu City (TW); Po-Han FU, Hsin-Chu City (TW)

(21) Appl. No.: 17/981,885

(22) Filed: Nov. 7, 2022

(51) Int. Cl. G02B 1/00

(52) U.S. Cl. CPC G02B 1/002; G02B 5/005; G02B 2207/101

(57) ABSTRACT

An optical device is provided. The optical device includes a substrate that has a top surface and a bottom surface. The optical device also includes a cover layer disposed on the substrate, and the cover layer has a top surface and a bottom surface. The top surface of the cover layer faces the bottom surface of the substrate. The optical device further includes a first meta structure disposed on the bottom surface of the substrate and a second meta structure disposed on the top surface of the cover layer. Moreover, the optical device includes a detector disposed on the bottom surface of the cover layer.

### BACKGROUND

### Field of the Invention

The embodiments of the present disclosure relate to an optical device, and in particular they relate to the optical device that includes a first meta structure disposed on the substrate and a second meta structure disposed on the cover layer.

### Description of the Related Art

Optical devices (e.g., charge-coupled device (CCD) image sensors, complementary metal-oxide semiconductor (CMOS) image sensors, and so on) have been widely used in various image-capturing apparatuses such as digital still-image cameras, digital video cameras, and the like. To obtain high-quality images and/or videos, a lens assembly including a combination of a plurality of lenses may be used in an optical device.

An optical device that includes a meta structure is a diffractive optical device in which individual waveguide elements have subwavelength spacing and have a planar profile. Compared to traditional refractive optical devices, the optical device that includes a meta structure abruptly introduces phase shifts onto light field. This enables the meta structure to have a thickness on the order of the wavelength of light at which they are designed to operate, whereas traditional refractive surfaces have thicknesses that are 10-100 times (or more) larger than the wavelength of light at which they are designed to operate.

However, a general optical device includes single meta structure, so that it is not possible to control the chief ray angle (CRA) and correct for grid distortion simultaneously.

### BRIEF SUMMARY

In some embodiments of the present disclosure, the optical device includes at least a first meta structure disposed on the substrate and a second meta structure disposed on the cover layer, which may obtain good image clarity and improve the distortion of the optical device over a large field of view.

In accordance with some embodiments of the present disclosure, an optical device is provided. The optical device includes a substrate that has a top surface and a bottom surface. The optical device also includes a cover layer disposed on the substrate, and the cover layer has a top surface and a bottom surface. The top surface of the cover layer faces the bottom surface of the substrate. The optical device further includes a first meta structure disposed on the bottom surface of the substrate and a second meta structure disposed on the top surface of the cover layer. Moreover, the optical device includes a detector disposed on the bottom surface of the cover layer.

In some embodiments, the optical device further includes a light-shielding layer disposed on the top surface of the substrate, and the light-shielding layer has an aperture.

In some embodiments, the light-shielding layer is in direct contact with the substrate.

In some embodiments, the optical device further includes a third meta structure disposed on the top surface of the substrate. Part of the third meta structure is disposed inside the aperture.

In some embodiments, the light-shielding layer is separated from the substrate.

In some embodiments, the optical device further includes a third meta structure disposed between the substrate and the light-shielding layer.

In some embodiments, the first meta structure includes first nano-pillars that have different sizes, and the second meta structure includes second nano-pillars that have different sizes.

In some embodiments, the first nano-pillars and the second nano-pillars comprise dielectric materials.

In some embodiments, the first nano-pillars or the second nano-pillars form a square, a hexagon, or a circle.

In some embodiments, the first nano-pillars and the second nano-pillars are a plurality of lattices.

In some embodiments, the optical distortion of the optical device is less than 10% over a field of view of 40 degrees.

In some embodiments, the modulation transfer function of the optical device at 100 cycles/mm spatial frequency is more than 50%.

In some embodiments, the f-number of the optical device is between 1.5 and 3.

In some embodiments, the thickness of the substrate is between 0.2 mm and 1.0 mm.

In some embodiments, light with a non-zero incident angle has a non-zero chief ray angle through the first meta structure and the second meta structure.

### BRIEF DESCRIPTION OF THE DRAWINGS

The disclosure can be more fully understood from the following detailed description when read with the accompanying figures. It is worth noting that, in accordance with standard practice in the industry, various features are not drawn to scale. In fact, the dimensions of the various features may be arbitrarily increased or reduced for clarity of discussion.

FIG. 1 is a cross-sectional view illustrating a portion of the optical device in accordance with some embodiments of the present disclosure.

FIG. 2A is a partial three-dimensional schematic diagram illustrating the first meta structure according to some embodiments of the present disclosure.

FIG. 2B is a partial top view of the first meta structure in FIG. 2A.

FIG. 3A is a partial three-dimensional schematic diagram illustrating the first meta structure according to some other embodiments of the present disclosure.

FIG. 3B is a partial top view of the first meta structure in FIG. 3A.

FIG. 4A is a partial three-dimensional schematic diagram illustrating the first meta structure according to some other embodiments of the present disclosure.

FIG. 4B is a partial top view of the first meta structure in FIG. 4A.

FIG. 5 is a cross-sectional view illustrating a portion of the optical device in accordance with some other embodiments of the present disclosure.

FIG. 6 is a cross-sectional view illustrating a portion of the optical device in accordance with some other embodiments of the present disclosure.

FIG. 7 is a cross-sectional view illustrating a portion of the optical device in accordance with some other embodiments of the present disclosure.

### DETAILED DESCRIPTION OF THE INVENTION

The following disclosure provides many different embodiments, or examples, for implementing different features of the subject matter provided. Specific examples of components and arrangements are described below to simplify the present disclosure. These are, of course, merely examples and are not intended to be limiting. For example, a first feature is formed on a second feature in the description that follows may include embodiments in which the first feature and second feature are formed in direct contact, and may also include embodiments in which additional features may be formed between the first feature and second feature, so that the first feature and second feature may not be in direct contact.

It should be understood that additional steps may be implemented before, during, or after the illustrated methods, and some steps might be replaced or omitted in other embodiments of the illustrated methods.

Furthermore, spatially relative terms, such as “beneath,” “below,” “lower,” “on,” “above,” “upper” and the like, may be used herein for ease of description to describe one element or feature's relationship to other elements or features as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present disclosure, the terms “about,” “approximately” and “substantially” typically mean+/−20% of the stated value, more typically +/−10% of the stated value, more typically +/−5% of the stated value, more typically +/−3% of the stated value, more typically +/−2% of the stated value, more typically +/−1% of the stated value and even more typically +1-0.5% of the stated value. The stated value of the present disclosure is an approximate value. That is, when there is no specific description of the terms “about,” “approximately” and “substantially”, the stated value includes the meaning of “about,” “approximately” or “substantially”.

Unless otherwise defined, all terms (including technical and scientific terms) used herein have the same meaning as commonly understood by one of ordinary skill in the art to which this disclosure belongs. It should be understood that terms such as those defined in commonly used dictionaries should be interpreted as having a meaning that is consistent with their meaning in the context of the relevant art and will not be interpreted in an idealized or overly formal sense unless expressly so defined in the embodiments of the present disclosure.

The present disclosure may repeat reference numerals and/or letters in following embodiments. This repetition is for the purpose of simplicity and clarity and does not in itself dictate a relationship between the various embodiments and/or configurations discussed.

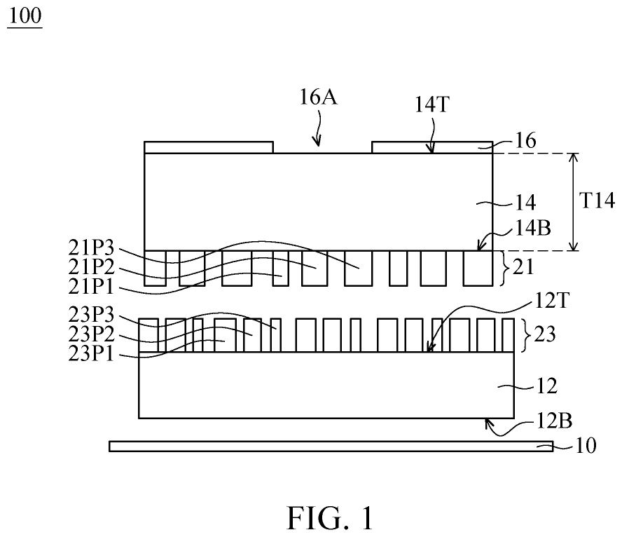

FIG. 1 is a cross-sectional view illustrating a portion of the optical device 100 in accordance with some embodiments of the present disclosure. It should be noted that some components of the optical device 100 have been omitted in FIG. 1 for the sake of brevity.

Referring to FIG. 1, in some embodiments, the optical device 100 includes a substrate 14 that has a top surface 14T and a bottom surface 14B. For example, the substrate 14 may include silicon oxide (SiO 2), polymers that have a refractive index of about 1.5 (e.g., polymethylmethacrylate (PMMA), polydimethylsiloxane (PDMS), polymethylpentene (PMP)), or a combination thereof, but the present disclosure is not limited thereto. Alternately, the substrate 14 may be a semiconductor-on-insulator (SOI) substrate. As shown in FIG. 1, in some embodiments, the thickness T14 of the substrate 14 is between about 0.2 mm and about 1.0 mm.

Referring to FIG. 1, in some embodiments, the optical device 100 includes a cover layer 12 disposed on the substrate 14, and the cover layer 12 has a top surface 12T and a bottom surface 12B. In more detail, the top surface 12T of the cover layer 12 faces the bottom surface 14B of the substrate 14. The cover layer 12 does not impact the imaging performance of the optical device 100 but provides other functionality (e.g., either optical or structural). For example, the optical device 100 may be integrated with the CMOS image sensor (CIS) as the cover layer 12, but the present disclosure is not limited thereto. Moreover, the cover layer 12 may have a thickness of about 0.2 mm through about 0.5 mm, but the present disclosure is not limited thereto.

Referring to FIG. 1, in some embodiments, the optical device 100 includes a first meta structure 21 disposed on the bottom surface 14B of the substrate 14 and a second meta structure 23 disposed on the top surface 12T of the cover layer 12. In other words, the first meta structure 21 and the second meta structure 23 are disposed on different components and face each other.

As shown in FIG. 1, in some embodiments, the first meta structure 21 includes first nano-pillars 21P1, 21P2, 21P3 that have different sizes, and the second meta structure 23 includes second nano-pillars 23P1, 23P2, 23P3 that have different sizes. For example, the first nano-pillars 21P1, 21P2, 21P3 are nano-pillars that have different diameters, and the second nano-pillars 23P1, 23P2, 23P3 are nano-pillars that have different diameters, but the present disclosure is not limited thereto.

In some embodiments, the first nano-pillars 21P1, 21P2, 21P3 and the second nano-pillars 23P1, 23P2, 23P3 include dielectric materials, such as SiO₂, Al₂O₃, the like, or any other applicable metal oxide or metal nitride. Alternately, the first nano-pillars 21P1, 21P2, 21P3 and the second nano-pillars 23P1, 23P2, 23P3 may include single crystal silicon, polycrystalline silicon (poly Si), amorphous silicon, Si₃N₄, GaP, TiO₂, AlSb, AlAs, AlGaAs, AlGaInP, BP, ZnGeP₂, any other applicable material, or a combination thereof, but the present disclosure is not limited thereto. In some embodiments, the first nano-pillars 21P1, 21P2, 21P3 and the second nano-pillars 23P1, 23P2, 23P3 are a plurality of lattices.

The first nano-pillars (e.g., 21P1, 21P2, 21P3) of the first meta structure 21 and the second nano-pillars (e.g., 23P1, 23P2, 23P3) of the second meta structure 23 may be formed by a photoresist reflow method, a hot embossing method, any other applicable method, or a combination thereof. Moreover, the steps of forming the first nano-pillars (e.g., 21P1, 21P2, 21P3) and the second nano-pillars (e.g., 23P1, 23P2, 23P3) may include a spin coating process, a lithography process, an etching process, any other applicable process, or a combination thereof, but the present disclosure is not limited thereto.

Referring to FIG. 1, in some embodiments, the optical device 100 includes a detector 10 disposed on the bottom surface 12B of the cover layer 12. For example, the detector 10 may be a single monolithic image sensor or a pixel array. Such image sensors and pixel arrays may take any suitable form including, for example, CMOS sensors. The detector 10 may include a semiconductor substrate, such as a wafer or a chip. For example, the semiconductor substrate may include silicon, but the present disclosure is not limited thereto.

Moreover, the detector 10 may include a plurality of photoelectric conversion elements for receiving visible light or IR/NIR light, but the present disclosure is not limited thereto. The visible light may include, for example, red light, green light, blue light, yellow light, white light, cyan light, or magenta light, which may be adjusted depending on actual needs.

As shown in FIG. 1, in some embodiments, the optical device 100 further includes a light-shielding layer 16 disposed on the top surface 14T of the substrate 14, and the light-shielding layer 16 has an aperture 16A. For example, the light-shielding layer 16 may include a metal, such as copper (Cu), silver (Ag), or the like, but the present disclosure is not limited thereto. Alternately, the light-shielding layer 16 may include a photoresist (e.g., black photoresist, or any other applicable photoresist which is not transparent), an ink (e.g., black ink, or any other applicable ink which is not transparent), a molding compound (e.g., black molding compound, or other applicable molding compound which is not transparent), a solder mask (e.g., black solder mask, or any other applicable solder mask which is not transparent), an epoxy polymer, any other applicable material, or a combination thereof, but the present disclosure is not limited thereto. Moreover, the light-shielding layer 16 may include a light curing material, a thermal curing material, or a combination thereof.

As the embodiment shown in FIG. 1, the light-shielding layer 16 is in direct contact with the substrate 14. In more detail, the light-shielding layer 16 is in direct contact with the top surface 14T of the substrate 14.

In the embodiments according to the present disclosure, light with a non-zero incident angle has a non-zero chief ray angle (CRA) through the first meta structure 21 and the second meta structure 23. In more detail, by the arrangement and sizes of the first nano-pillars (e.g., 21P1, 21P2, 21P3) of the first meta structure 21 and the arrangement and sizes of the second nano-pillars (e.g., 23P1, 23P2, 23P3) of the second meta structure 23, the chief ray angle (CRA) of the incident light may be adjusted depending to actual needs.

In the embodiment shown in FIG. 1, the f-number (F/#) of the optical device 100 is about 2.2, and the equivalent focal length of the optical device 100 is about 0.6 mm. In this embodiment, the optical distortion of the optical device 100 is 7.8% over a field of view (FOV) of 40 degrees. Moreover, the modulation transfer function (MTF) of the optical device 100 at 100 cycles/mm spatial frequency is more than about 50%. In other words, due to the first meta structure 21 and the second meta structure 23, the optical device 100 may obtain better image clarity and improve the distortion of the optical device over a large field of view.

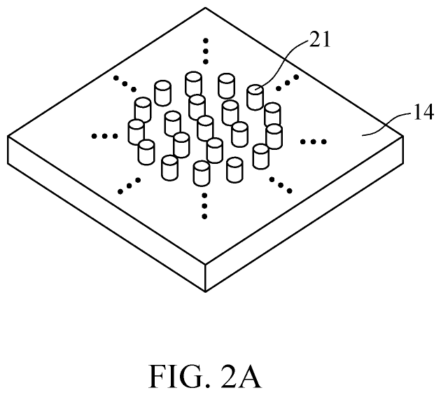

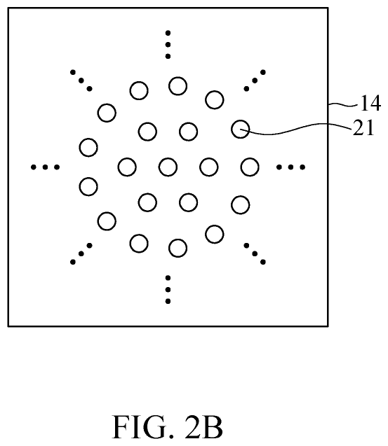

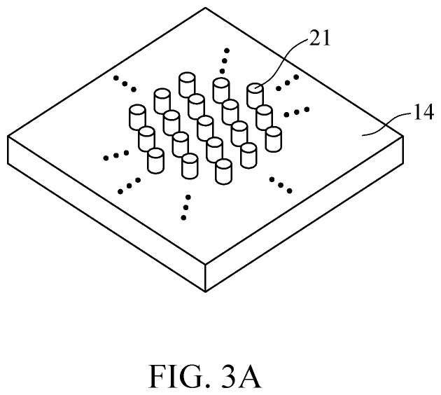

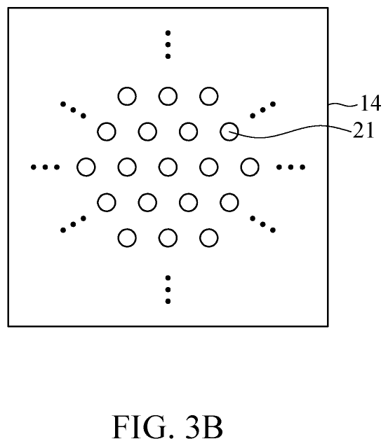

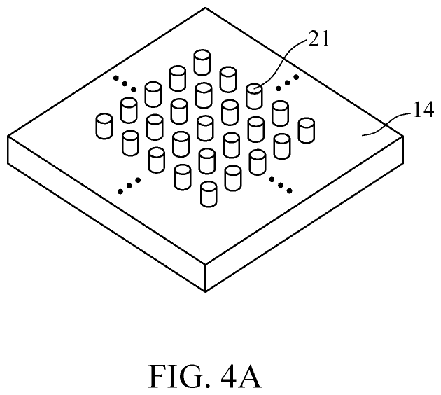

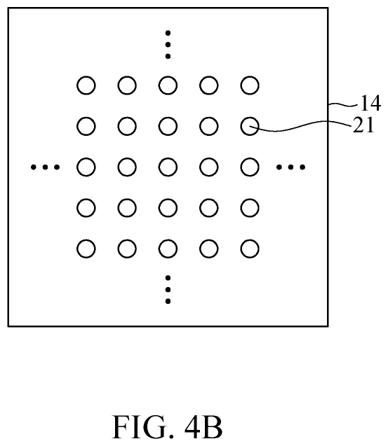

FIG. 2A is a partial three-dimensional schematic diagram illustrating the first meta structure 21 according to some embodiments of the present disclosure. FIG. 2B is a partial top view of the first meta structure in FIG. 2A. FIG. 3A is a partial three-dimensional schematic diagram illustrating the first meta structure 21 according to some other embodiments of the present disclosure. FIG. 3B is a partial top view of the first meta structure in FIG. 3A. FIG. 4A is a partial three-dimensional schematic diagram illustrating the first meta structure 21 according to some other embodiments of the present disclosure. FIG. 4B is a partial top view of the first meta structure in FIG. 4A.

It should be noted that although the first nano-pillars of the first meta structure 21 are shown to have the same diameter in FIG. 2A-4B, the first nano-pillars of the first meta structure 21 may actually have different sizes. In addition, the arrangement of the second nano-pillars of the second meta structure 23 may also be similar to those shown in FIG. 2A-4B, which will not be repeated here.

As show in FIG. 2A and FIG. 2B, in some embodiments, the first nano-pillars of the first meta structure 21 (or the second nano-pillars of the second meta structure 23) form a circle.

As show in FIG. 3A and FIG. 3B, in some embodiments, the first nano-pillars of the first meta structure 21 (or the second nano-pillars of the second meta structure 23) form a hexagon.

As show in FIG. 4A and FIG. 4B, in some embodiments, the first nano-pillars of the first meta structure 21 (or the second nano-pillars of the second meta structure 23) form a square.

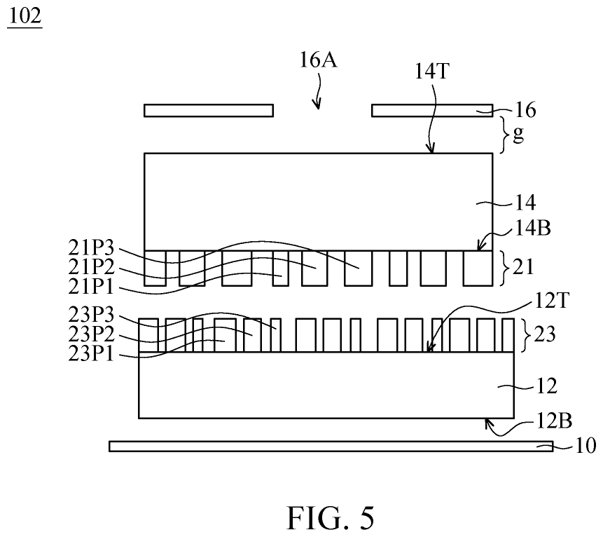

FIG. 5 is a cross-sectional view illustrating a portion of the optical device 102 in accordance with some other embodiments of the present disclosure. Similarly, some components of the optical device 102 have been omitted in FIG. 2 for the sake of brevity.

The optical device 102 shown in FIG. 5 has a similar structure to the optical device 100 shown in FIG. 1. That is, the optical device 102 includes a substrate 14 and a cover layer 12. The substrate 14 has a top surface 14T and a bottom surface 14B, the cover layer 12 has a top surface 12T and a bottom surface 12B, and the cover layer 12 is disposed on the substrate 14. The top surface 12T of the cover layer 12 faces the bottom surface 14B of the substrate 14. The optical device 102 also includes a first meta structure 21 disposed on the bottom surface 14B of the substrate 14 and a second meta structure 23 disposed on the top surface 12T of the cover layer 12. The optical device 102 further includes a detector disposed on the bottom surface 12B of the cover layer 12.

Moreover, the optical device 100 further includes a light-shielding layer 16 disposed on the top surface 14T of the substrate 14, and the light-shielding layer 16 has an aperture 16A. As shown in FIG. 5, in this embodiment, the light-shielding layer 16 is separated from the substrate 14. That is, a gap g may be formed between the substrate 14 and the light-shielding layer 16.

In the embodiment shown in FIG. 5, the f-number (F/#) of the optical device 102 is about 2.2, and the equivalent focal length of the optical device 102 is about 0.6 mm. In this embodiment, the optical distortion of the optical device 102 is 9.5% over a field of view (FOV) of 40 degrees. Moreover, the modulation transfer function (MTF) of the optical device 102 at 100 cycles/mm spatial frequency is more than about 50%. In other words, due to the first meta structure 21 and the second meta structure 23, the optical device 102 may obtain better image clarity and improve the distortion of the optical device over a large field of view.

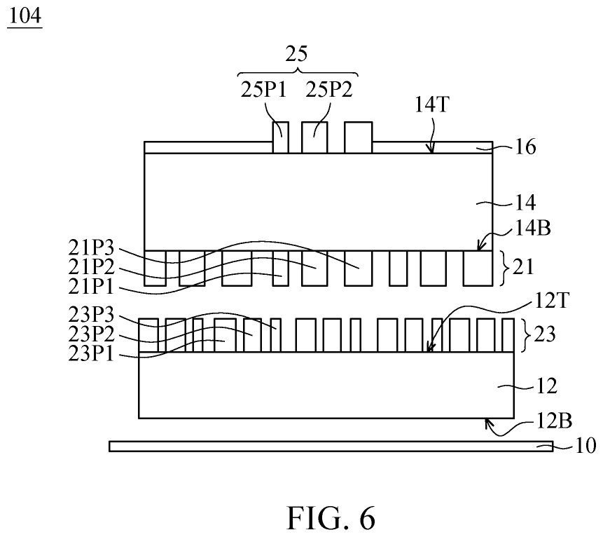

FIG. 6 is a cross-sectional view illustrating a portion of the optical device 104 in accordance with some other embodiments of the present disclosure. Similarly, some components of the optical device 104 have been omitted in FIG. 2 for the sake of brevity.

The optical device 104 shown in FIG. 6 has a similar structure to the optical device 100 shown in FIG. 1. The main difference from the optical device 100 shown in FIG. 1 is that the optical device 104 shown in FIG. 6 further includes a third meta structure 25 disposed on the top surface 14T of the substrate 14, and part of the third meta structure 25 is disposed inside the aperture 16A of the light-shielding layer 16.

In more detail, as shown in FIG. 6, in some embodiments, the third meta structure 25 includes third nano-pillars 25P1, 25P2 that have different sizes. For example, the third nano-pillars 25P1, 25P2 are nano-pillars that have different diameters, but the present disclosure is not limited thereto.

In the embodiment shown in FIG. 6, the f-number (F/#) of the optical device 104 is about 2.2, and the equivalent focal length of the optical device 104 is about 0.6 mm. In this embodiment, the optical distortion of the optical device 104 is 7.2% over a field of view (FOV) of 40 degrees. Moreover, the modulation transfer function (MTF) of the optical device 104 at 100 cycles/mm spatial frequency is more than about 50%. In other words, due to the first meta structure 21, the second meta structure 23, and the third meta structure 25, the optical device 104 may obtain better image clarity and improve the distortion of the optical device over a large field of view.

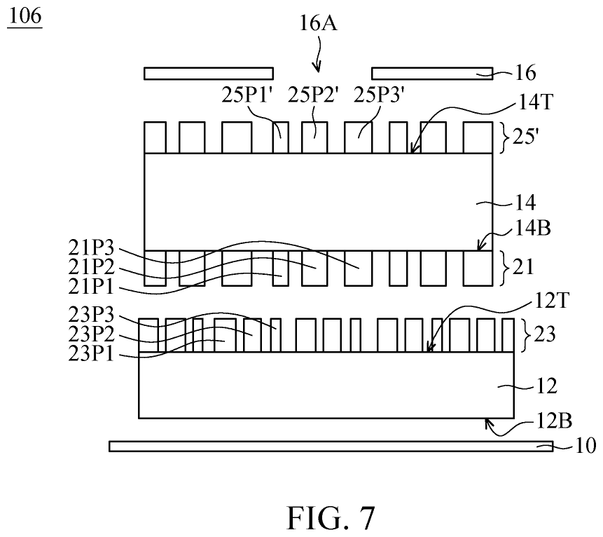

FIG. 7 is a cross-sectional view illustrating a portion of the optical device 106 in accordance with some other embodiments of the present disclosure. Similarly, some components of the optical device 106 have been omitted in FIG. 7 for the sake of brevity.

The optical device 106 shown in FIG. 7 has a similar structure to the optical device 102 shown in FIG. 5. The main difference from the optical device 102 shown in FIG. is that the optical device 106 shown in FIG. 7 further includes a third meta structure 25′ disposed between the substrate 14 and the light-shielding layer 16.

In more detail, as shown in FIG. 7, in some embodiments, the third meta structure 25′ includes third nano-pillars 25P1′, 25P2′, 25P3′ that have different sizes. For example, the third nano-pillars 25P1′, 25P2′, 25P3′ are nano-pillars that have different diameters, but the present disclosure is not limited thereto.

In the embodiment shown in FIG. 7, the f-number (F/#) of the optical device 106 is about 2.2, and the equivalent focal length of the optical device 106 is about 0.6 mm. In this embodiment, the optical distortion of the optical device 106 is 5.0% over a field of view (FOV) of 40 degrees. Moreover, the modulation transfer function (MTF) of the optical device 106 at 100 cycles/mm spatial frequency is more than about 50%. In other words, due to the first meta structure 21, the second meta structure 23, and the third meta structure 25′, the optical device 106 may obtain better image clarity and improve the distortion of the optical device over a large field of view.

In summary, the optical device according to the embodiments of the present disclosure includes at least two meta structures (e.g., first meta structure 21 and second meta structure 23) disposed on different components and face each other, so that the optical distortion of the optical device is less than 10% over a large field of view of (e.g., 40 degrees), which is smaller than the optical distortion of the traditional optical device (e.g., 23%).

Moreover, the modulation transfer function (MTF) of the optical device according to the embodiments of the present disclosure at 100 cycles/mm spatial frequency is more than about 50% (which means good image clarity). Therefore, it is possible to control the chief ray angle (CRA) and correct for grid distortion simultaneously in the optical device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure. Therefore, the scope of protection should be determined through the claims. In addition, although some embodiments of the present disclosure are disclosed above, they are not intended to limit the scope of the present disclosure.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

What is claimed is:

1. An optical device, comprising:
a substrate having a top surface and a bottom surface;
a cover layer disposed on the substrate and having a top surface and a bottom surface, wherein the top surface of the cover layer faces the bottom surface of the substrate;
a first meta structure disposed on the bottom surface of the substrate;
a second meta structure disposed on the top surface of the cover layer; and
a detector disposed on the bottom surface of the cover layer.

2. The optical device as claimed in claim 1, further comprising:
a light-shielding layer disposed on the top surface of the substrate, wherein the light-shielding layer has an aperture.

3. The optical device as claimed in claim 2, wherein the light-shielding layer is in direct contact with the substrate.

4. The optical device as claimed in claim 3, further comprising:
a third meta structure disposed on the top surface of the substrate,
wherein part of the third meta structure is disposed inside the aperture.

5. The optical device as claimed in claim 2, wherein the light-shielding layer is separated from the substrate.

6. The optical device as claimed in claim 5, further comprising:
a third meta structure disposed between the substrate and the light-shielding layer.

7. The optical device as claimed in claim 1, wherein the first meta structure comprises first nano-pillars that have different sizes, and the second meta structure comprises second nano-pillars that have different sizes.

8. The optical device as claimed in claim 7, wherein the first nano-pillars and the second nano-pillars comprise dielectric materials.

9. The optical device as claimed in claim 7, wherein the first nano-pillars or the second nano-pillars form a square, a hexagon, or a circle.

10. The optical device as claimed in claim 7, wherein the first nano-pillars and the second nano-pillars are a plurality of lattices.

11. The optical device as claimed in claim 1, wherein an optical distortion of the optical device is less than 10% over a field of view of 40 degrees.

12. The optical device as claimed in claim 1, wherein a modulation transfer function of the optical device at 100 cycles/mm spatial frequency is more than 50%.

13. The optical device as claimed in claim 1, wherein an f-number of the optical device is between 1.5 and 3.

14. The optical device as claimed in claim 1, wherein a thickness of the substrate is between 0.2 mm and 1.0 mm.

15. The optical device as claimed in claim 1, wherein light with a non-zero incident angle has a non-zero chief ray angle through the first meta structure and the second meta structure.
